(19) United States
(12) Patent Application Publication
(10) Pub. No.: US 2008/0005059 A1
(43) Pub. Date: Jan. 3, 2008

(54) Framework for storage and transmission of medical images

(76) Inventors: John Colang, Placitas, NM (US); Adam Wright, Corrales, NM (US); Mike A. Speer, Placitas, NM (US); Ajith Illendula, Albuquerque, NM (US)

Correspondence Address: DARBY & DARBY P.C., P.O. BOX 770, Church Street Station, New York, NY, 10008-0770, US

(21) Appl. No.: 11/478,358

(22) Filed: Jun. 30, 2006

(51) Int. Cl. G06F 17/30

(52) U.S. Cl. 707/1

(57) ABSTRACT

A method and system to maintain a personal health record, including, obtaining data using a medical imaging device, storing the data in a picture archiving and communication system, determining which of the data stored in the picture archiving and communication system is to be stored in the personal health record, and transmitting the data to be stored in the personal health record to an internet accessible storage device based on the determination.

### FIELD OF INVENTION

Embodiments of the invention relate to the field of portable patient health records, and may include methods and devices for standardizing health data and making that data available to patients and care providers. More specifically, embodiments of the invention relate to storing medical image data, converting the image data to a standard format, and providing that data to a patient in a portable format.

### BACKGROUND

Every day, terabytes of data are produced as medical images are created. This data is typically in the form of CT scans, ultrasound scans, nuclear medicine images, PET scans, radiological images, MRI images, cardiology, or pathology images. This data is often stored in various Picture Archiving and Communication Systems (PACS) which store data in a wide variety of different formats.

With such large volumes of data being stored in PACS, it can be difficult for physicians to gain access to important data or images that may be used for diagnostic and/or treatment purposes. For example, an emergency room physician may not have the time to search through all of a patient's records to find a useful image that may aid the physician. Furthermore, even if the physician was able to identify a useful image, the physician may not be able to access the data due to the format in which it is stored.

### BRIEF DESCRIPTION OF THE DRAWINGS

FIG. 1 illustrates an exemplary method for capturing and storing data in a PHR according to an embodiment of the invention.

FIG. 2 illustrates an exemplary system for capturing and storing data in a PHR according to an embodiment of the invention.

FIGS. 3A and 3B illustrate exemplary medical image data.

### DETAILED DESCRIPTION

In today's world of global travel it is increasingly common for people to become sick or injured in a place far from their normally used health care providers. As a result, patients and the physicians who treat them are often unable to access relevant medical records and data in an efficient and timely manner. This inability to access patient related data can often result in wasted time and money in trying to recreate data, or even in misdiagnosis and resulting complications or death.

Accordingly, various embodiments of the invention include methods and systems of generating, populating and maintaining personal health records (PHR's) that may be used to store patient related data. By using a PHR, a patient, or a physician, is able to select which data from among the vast amounts of available medical data to store in the PHR, as well as the format in which the data is to be stored. By storing only select data or images in a PHR, and storing the images and/or data in a standard format, treating physicians are provided a tool through which they can receive relevant medical data in a timely and efficient manner, thereby increasing the chances of accurate diagnoses and successful treatments.

PACS commonly store the entirety of a patient's medical images, and while this data is very useful for long term patient care and treatment, the shear amount of data involved can serve to obfuscate information that may be critical in quickly and efficiently diagnosing or treating a patient. There are many instances where a single or a limited number of images may prove to be much more helpful to a physician by providing information that clearly indicates a previously identified condition or a previous state of a patient. Accordingly, various embodiments of the invention allow for a patient to select specific images or data from among the data stored in a PACS to be transferred to and stored in the patient's PHR. By identifying and choosing specific data or images to store in the PHR during non-emergency conditions, the patient can ensure that a treating physician is able to save critical time and effort during a later emergency by examining data that was previously determined to be useful and avoiding a review of a patient's entire PACS record.

A common difficulty encountered in modern medicine involves patients who use physicians that belong to different health care systems. Often, the different health care systems use different PACS which store data in different formats. This renders the medical images useless to physicians in other health care systems. Accordingly, in various embodiments of the invention images are reformatted and stored in PHR's in a standard format. By standardizing the format of the data stored in the PHR'S, and in some instances using XML as a standard wrapper, these embodiments of the invention allow for the data to be easily transferred between, and viewed by, physicians that would normally be unable to view the data.

In further embodiments of the invention, PHR's are maintained on internet accessible servers such that they may be accessed from any device having an internet connection. By making the PHR's so accessible, it is possible for physicians almost anywhere in the world to obtain critical patient data.

Various systems and methods are detailed below showing examples of how to populate a PHR according to various embodiments of the invention. The below-described systems and methods allow a user to select medical images created by a medical provider and to transfer those images to a PHk. The embodiments include software that can perform the incorporation and integration of the patient's medical images from a private enterprise PACS, such as a hospital, into a PHR.

Patient medical images and report data can be acquired by various previously known systems or methods. Such data can include, but is not limited to, medical imaging sections including diagnostic radiology, ultrasound, CT, PET scans, nuclear medicine, MRI, CT/PET fusion scans, bone densitometry studies, cardiology images, or laboratory electron microscopy images. The image data may be stored by a custodian at a remote location on a server system suitable for storing image data. A PHR may contain various components including, but not limited to, core patient data. Core patient data may include, but is not limited to, a patient profile, allergies, organ donation information, advance directive information, height, weight, age, risk factors, blood pressure, current diagnoses, current medications, medical history, list of all physicians and contact information, family history, lab and pathology results section.

Custodians of the medical image data may provide web-based interfaces to allow patients or other users to select patient record data such as images to import into PHR's. These web-based interfaces may be configured to allow patients to populate and maintain their own PHR's. Using the Internet, PHR's may be accessed at any Internet location through a secured user authentication pathway. The PHR's may utilize a secured database that is accessible only to authorized providers. Authorization can be performed using various methods now known or later developed.

A data custodian, such as a hospital, or another enterprise may utilize a plug-in software device to allow a search of a PACS system to deliver data or images to a requesting PHR database for inclusion into a PHR. Individual PACS may be equipped with a server component of this PHR-Port software. The data (images) and reports will be wrapped in an XML standard transport package to be shipped to the requestor.

In some embodiments, the software can include a method for standardization of data and image files. In some embodiments of the invention, the data is standardized prior to transmission to a PHR; while in other embodiments, the data may be standardized after it is transferred to a PHR. As part of a transfer process, the software may convert image data to a standard lossless PHR image file format prior to storage in the PHR. In other embodiments the transfer is performed in a PHS standard format. In yet further embodiments, the standards use XML packaging and pre-defined tags.

According to various embodiments of the invention, patients who have a PHR may have a client component of a PHR-Port software loaded on their personal device (such as a PC) to receive, archive, and transmit the images to the PHR in a DICOM/HL7/XMLcompliant format. Thus, there can be transmission to other PACS systems via a DICOM/HL7/XML compliant transporter. A local PC client may be utilized. In some embodiments of the invention, patients may become full custodians of their own medical images, and the patients may transmit portions of their medical records to any downstream recipient. The patients may transmit the records using industry standard DICOM and/or HL7 protocols wrapped in an standard XML wrapper to facilitate parsing into the PHR. Various systems may ensure that recipients of the medical record data have Add-on software installed prior to data transfer.

In various embodiments of the invention, a PHR may format and present medical images and data stored therein in an easy to read and user friendly format. Patients may then share medical information with other physicians or health care workers at the patients' discretion. Patients may also be able to print or email any of the data stored in the PHR. Data that has been delivered to a patient's PHR may be sent to a downstream recipient using industry standard DICOM and HL7 protocols. Recipients of the images may utilize add-on software to process the data. A PHR may also contain data related to patient exams and reports, thereby enabling a controlled and secure retrieval of important medical data from within a hospital as well as from off-site using any web-enabled device.

Various embodiments of the invention provide an enhanced viability PHR and enhanced downstream transmission of medical images to health care providers in a DICOM, HL7 compliant format. Third party PACS Viewers and/or DICOM Object translators may be used as intermediary agents. Various technologies may be utilized to format and/or re-position data in a PHR enclosed in an XML wrapper. Parsers may then interpret the standard by using the XML tags and position the data and images appropriately.

In some embodiments, images stored in a PHR may provide a reasonable rendition of previously interpreted images along with the written report. That is, in some embodiments, the resultant images are for reference purposes only for patients and their physicians. In other embodiments, images can be of sufficient diagnostic quality to be interpreted by a physician.

Various embodiments of the invention include: a method to maintain a personal health record comprising obtaining data using a medical imaging device; storing the data in a picture archiving and communication system; determining which of the data stored in the picture archiving and communication system is to be stored in a personal health record; transmitting the data to be stored in the personal health record to an internet accessible storage device based on the determination.

Some of these embodiments may further comprise reformatting the data to be stored in the personal health record to a standard format; annotating the obtained data to indicate results of an analysis of the data, while in others, the standard format is a JPEG format, and/or the obtained data comprises a plurality of images, and the data to be stored in the personal health record is a single image from among the plurality of images.

Further embodiments of the invention may include, a personal health record system, comprising: a picture archiving and communication system to store a plurality of medical image data sets, wherein at least one of the medical image data sets comprises one or more images; and an internet accessible personal health record server comprising a storage device; wherein at least one image of at least one of the medical image data sets is selected and stored in the storage device of the personal health record server.

In additional embodiments of the invention: the data to be stored in the storage device of the personal health record is reformatted into a standard format; the standard format is a JPEG format; the data to be stored in the storage device of the personal health record is annotated to indicate results of an analysis of the data prior to storage; and/or personal data related to a patient is stored in the storage device of the personal health record.

Yet further embodiments of the invention may include, a system, comprising: a personal health storage device to store medical record data, including a plurality of images and personal data, and a software program adapted to transmit the medical record data to the storage device from a picture archiving and communication system.

In additional embodiments of the invention: the personal health storage device may be worn on a person; the personal health storage device may be a medical alert bracelet; the personal health storage device may be a smart card; and/or the personal health storage device may be a medical alert necklace.

Another embodiment of the invention may include computer readable medium, comprising a software program stored thereon, comprising: a code for obtaining medical image data, comprising a plurality of image data sets, from picture archiving and communication system; a code for formatting the obtained data into a standard image format; a code for selecting at least one image from at least one of the image data sets; a code for transmitting the selected image to a personal health record system having a storage device; and a code for storing the selected image in the storage device. In additional embodiments of the invention, the software program may further comprise a code for annotating the selected image to contain an analysis of the image. In yet more embodiments of the invention, a device may comprise a memory comprising the above software program, and the device may further comprise a processor to execute the software program. In these embodiments of the invention, the code for formatting the obtained data into a standard image format may use XML.

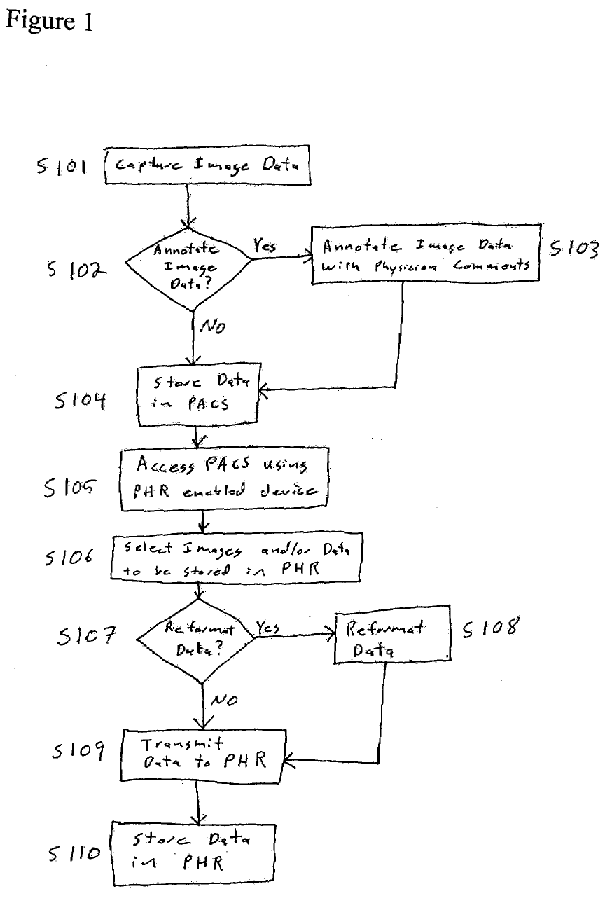

An exemplary method is illustrated in FIG. 1.

In S101 medical data is captured by a device or modality at a medical imaging provider. In this example, the data may be image data and the device may be an MRI machine at a hospital. Once the data is captured, it is decided at S102 if the data is to be annotated. For example, an interpreting physician may wish to append a report of his or her findings onto the data. In another example a physician may wish to place indicators on an MRI image indicating findings or pathology. If it is decided that an annotation is to be made, it is done so at S103. After the data is annotated, or if it decided that the data should not be annotated, the data is stored in a PACS at S104. In alternate embodiments of the invention, the data may be retrieved from the PACS and annotated at anytime. Also, annotated and non-annotated copies of the data may both be stored. Implemented workflow processes and hanging protocols at the imaging centers could incorporate this process into the workflow.

Once the data is stored in S104, it may be accessed using a PHR enabled device at S105. According to various embodiments of the invention, the PHR enabled device may be a PC, a cellular phone, a PDA, or any other web enabled device. At S 106, it is determined which data are to be stored in the PHR. This determination may be made by a patient who is to maintain his or her own PHR. In an alternate embodiment the determination may be made by a physician who has reviewed the data to identify the most helpful data, such as an image showing an injury most clearly. In yet another embodiment, the determination may be made by both a patient and a physician.

Once it is determined which data is to be stored in the PHR, it is determined at S107 if the data is to be reformatted. If the data is to be reformatted, it is reformatted at S 108, where the data is reformatted to a predetermined format. The data is then transmitted to the PHR at S109. In alternate embodiments of the invention, the data may be reformatted after it is transmitted to the PHR.

Once the data is transmitted, it is stored in the PHR at S110. The data may be stored in a standard format. In S110 the data may be stored in a network accessible memory device such as a secure server connected to the internet. However, in an alternate embodiment of the invention, the data may be stored on a portable device such as a memory stick or even copied to an optical disk. By storing the data on a portable device, a patient may ensure the confidentiality of his medical records as well as ensuring that in an emergency a treating physician will have access to the records.

In a further embodiment of the invention, the PHR may be stored in a memory device that may be worn by a user, such as a medical alert bracelet or necklace. In such an embodiment, an emergency room physician or other health care professional may be able to access a patient's entire medical history even if the patient is incapacitated or unable to communicate the information.

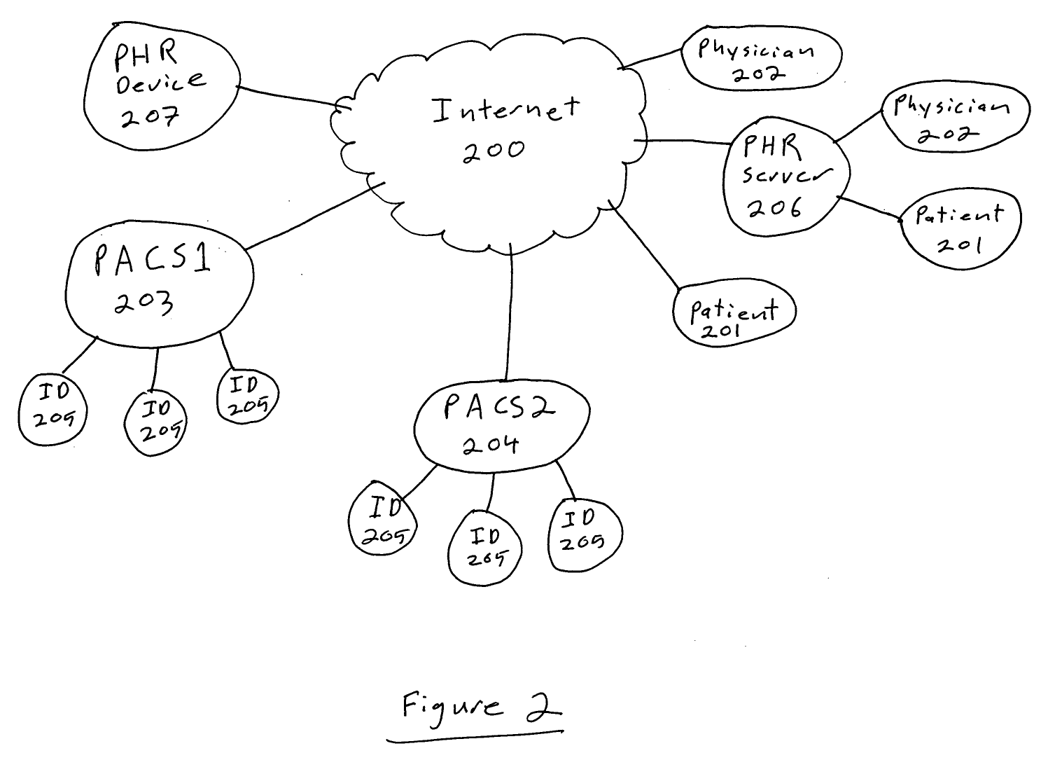

FIG. 2 illustrates an exemplary system for capturing and storing data in a PHR according to an embodiment of the invention. In the exemplary system an Internet 200 is connected to a patient 201, a physician 202, a first PACS 203, a second PACS 204, a PHR server 206 and a PHR device 207. Medical imaging devices 205 are connected to the first and second PACS 203, 204, and a second patient 201 and physician 202 are connected to the PHR server 206.

As shown in FIG. 2, PACS1 203 and PACS2 204, which store data in different formats, are populated with image data from medical imaging devices 205. In further embodiments of the invention, the data stored in the PACS is not limited to image data, and may include any other type of medical related data. A patient 201 or physician 202 using a PHR system may access PACS1 203 and PACS2 204 through the internet 200 to view or asses the data stored therein. The patient 201 or physician 202 may then choose images or other data stored in the PACS 203 and 204 to be transmitted to the PHR. The patient 201 or physician 202 may also choose which device the data is to be transmitted to, the PHR server 206 or the PHR device 207. In a further embodiment of the invention, the data may be transferred to both the PHR server 206 and the PHR device 207.

The data may then be transferred to the PHR using the internet 200, and the data may be reformatted into a standard format based on the predetermined settings of the PHR. For example, the data from PACS 1 203 may already be in a standard format and may be transmitted and stored without reformatting, while the data from PACS2 204 may be reformatted. Furthermore, the determination as to reformatting may depend on whether the data is being sent to the PHR server 206 or the PHR device 207. For example, data from PACS2 204 may be reformatted for storage in the PHR device 207, while it may be stored in its original format in the PHR server 206.

Additional patients 201 and physicians 202 without internet access may be connected directly to the PHR server 206.

According to various aspects of the invention, the data stored in the PHR is of a lower quality than the data stored in the PACS due to image resolution limitations on downstream display monitors.

According to yet another embodiment of the invention, a PHR can be used to transfer data from one PACS to another. For example, data stored in PACS1 203 may be transmitted to the PHR server 206 where it is reformatted and stored. The reformatted data may then be transferred to PACS2 204 where it may again be reformatted and then stored. In such a system, a patient may be able to ensure that medical data taken at different facilities which may belong to difference health care networks may be stored in at least one common PACS. This may help to ensure that a treating physician has access to all available data.

According to a further embodiment of the invention, data may be stored in a PACS as a Digital Imaging and Communications in Medicine (DICOM) object, which may be converted into a JPEG or other compliant image when it is transmitted to, or stored at, a PHR. In some embodiments of the invention data may be transmitted using email. In some embodiments, a sample report and image may be sent to a PHR. This image would remain in the PHR until archived or deleted by the patient. This may not affect the image stored in the foreign PACS system.

In a further embodiment of the invention, a PHR may be updated automatically. For example a PHR compliant PACS may automatically update a PHR whenever new data is associated with a user account. In another example, the PACS may update the PHR on a time based cycle or a use based cycle. In some embodiments of the invention, the PACS informs the PHR that new data is available for the user to transmit, while in others the PACS transmits the data to the PHR automatically. In some embodiments of the invention, a physician is able to indicate which data or images should be transmitted to the PHR, and those data are transmitted automatically.

In other embodiments of the invention, the PHR may automatically query various PACS to determine if new data is available for transmission; in some of the embodiments the data may be automatically transmitted.

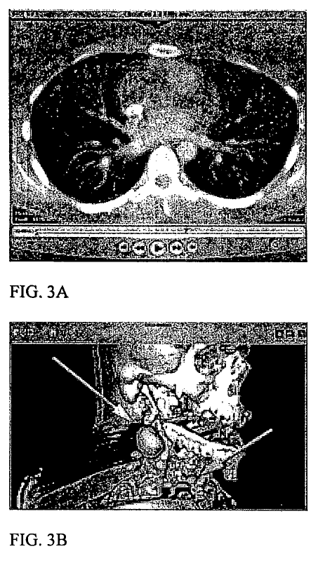

FIGS. 3A and 3B illustrate exemplary medical image data.

As used in the specification and claims, the singular forms “a”, “an” and “the” include plural references unless the context clearly dictates otherwise

1. A method to maintain a personal health record, comprising:
obtaining data using a medical imaging device;
storing the data in a picture archiving and communication system;
determining which of the data stored in the picture archiving and communication system is to be stored in the personal health record; and
transmitting the data to be stored in the personal health record to an internet accessible storage device based on the determination.

2. The method of claim 1, further comprising reformatting the data to be stored in the personal health record to a standard format.

3. The method of claim 2, wherein the standard format is a JPEG format.

4. The method of claim 1, wherein the obtained data comprises a plurality of images, and the data to be stored in the personal health record is a single image from among the plurality of images.

5. The method of claim 1, further comprising annotating the obtained data to indicate results of an analysis of the data.

6. The method of claim 4, further comprising annotating the obtained data to indicate results of an analysis of the data.

7. A personal health record system, comprising:
a picture archiving and communication system to store a plurality of medical image data sets, wherein at least one of the medical image data sets comprises one or more images; and
an internet accessible personal health record server comprising a storage device;
wherein at least one image of at least one of the medical image data sets is selected and stored in the storage device of the personal health record server.

8. The system of claim 7, wherein the data to be stored in the storage device of the personal health record is reformatted into a standard format.

9. The system of claim 8, wherein the standard format is a JPEG format.

10. The system of claim 7, wherein the data to be stored in the storage device of the personal health record is annotated to indicate results of an analysis of the data prior to storage.

11. The system of claim 7, wherein personal data related to a patient is stored in the storage device of the personal health record.

12. A system, comprising:
a personal health storage device to store medical record data, including a plurality of images and personal data, and a software program adapted to transmit the medical record data to the storage device from a picture archiving and communication system.

13. The system of claim 12, wherein the personal health storage device is to be worn on a person.

14. The system of claim 12, wherein the personal health storage device is a medical alert bracelet.

15. The system of claim 12, wherein the personal health storage device is a smart card.

16. The system of claim 12, wherein the personal health storage device is a medical alert necklace.

17. A computer readable medium, comprising a software program stored thereon, comprising:
a code to obtain medical image data, comprising a plurality of image data sets, from picture archiving and communication system;
a code to format the obtained data into a standard image format;
a code to select at least one image from at least one of the image data sets;
a code to transmit the selected image to a personal health record system having a storage device; and
a code to store the selected image in the storage device.

18. The computer readable medium of claim 17, further comprising a code to annotate the selected image to contain an analysis of the image.

19. A device, comprising a memory comprising the software program of claim 17.

20. The device comprising a memory comprising the software program of claim 17 and a processor to execute the software program.

21. The computer readable medium of claim 17, wherein the code to format the obtained data into a standard image format uses XML.
